(19) United States
(12) Patent Application Publication
(10) Pub. No.: US 2013/0169943 A1
(43) Pub. Date: Jul. 4, 2013

(54) IMAGE PROJECTION DEVICE AND ASSOCIATED IMAGE PROJECTION METHOD AND CALIBRATION METHOD

(71) Applicants: Shan-Chieh Wen, Tainan City (TW); Zhen-Yong Gao, Tainan City (TW); Ming-Huai Weng, Tainan City (TW)

(72) Inventors: Shan-Chieh Wen, Tainan City (TW); Zhen-Yong Gao, Tainan City (TW); Ming-Huai Weng, Tainan City (TW)

(21) Appl. No.: 13/342,188

(22) Filed: Jan. 2, 2012

(51) Int. Cl. G03B 21/14

(52) U.S. Cl. 353/70; 353/69; 353/121

(57) ABSTRACT

An image projection device includes an optical correction unit, a panel and a lens. The optical correction unit is utilized for receiving an image and pre-distorting the image to generate a pre-distorted image according to pre-distortion parameters. The panel is coupled to the optical correction unit, and is utilized for receiving and projecting the pre-distorted image. The lens is positioned in front of the panel, where the pre-distorted image projected from the panel passes through the lens, and the pre-distortion parameters correspond to distortion effects caused by the lens.

### BACKGROUND OF THE INVENTION

1. Field of the Invention

The present invention relates to an image projection device, and more particularly, to an image projection device which can eliminate distortion effects caused by a lens of the image projection device.

2. Description of the Prior Art

A typical image projection device has a lens positioned in front of a panel, so that images projected from the panel will pass through the lens and be shown on a plane surface. The shape of the projected image shown on the plane surface may be distorted due to the optical distortion effect caused by the lens, however. Please refer to FIG. 1 which illustrates a rectangular image being distorted by a lens 110, wherein the lengths of the vertical lines and the horizontal lines of the distorted image are varied in a non-linear manner, and the shape of the distorted image is trapezoidal. As well as the illustrated distortion, the image may undergo a color separation (i.e. lateral chromatic aberration) issue: a single white line of the image may be separated by the lens 110 into red, green and blue lines. The typical image projection device and lens may therefore result in the quality of the projected images being degraded.

### SUMMARY OF THE INVENTION

It is an objective of the present invention to provide an image projection device and associated method, which can eliminate distortion effects caused by a lens of the image projection device.

According to one embodiment of the present invention, an image projection device includes an optical correction unit, a panel and a lens. The optical correction unit is utilized for receiving an image and pre-distorting the image to generate a pre-distorted image according to pre-distortion parameters. The panel is coupled to the optical correction unit, and is utilized for receiving and projecting the pre-distorted image. The lens is positioned in front of the panel, where the pre-distorted image projected from the panel passes through the lens, and the pre-distortion parameters correspond to distortion effects caused by the lens.

According to another embodiment of the present invention, an image projecting method includes: receiving an image and pre-distorting the image to generate a pre-distorted image according to pre-distortion parameters; providing a panel to project the pre-distorted image; and providing a lens, positioned in front of the panel, wherein the pre-distorted image projected from the panel passes through the lens, where the pre-distortion parameters correspond to distortion effects caused by the lens.

According to another embodiment of the present invention, a calibration method includes: providing an image projection device; utilizing the image projection device to project a test pattern; capturing the test pattern projected from the image projection device; analyzing the captured test pattern to generate pre-distortion parameters, where the pre-distortion parameters correspond to distortion effects caused by a lens of the image projection device; and utilizing the image projection device to store the pre-distortion parameters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a rectangular image distorted by the lens.

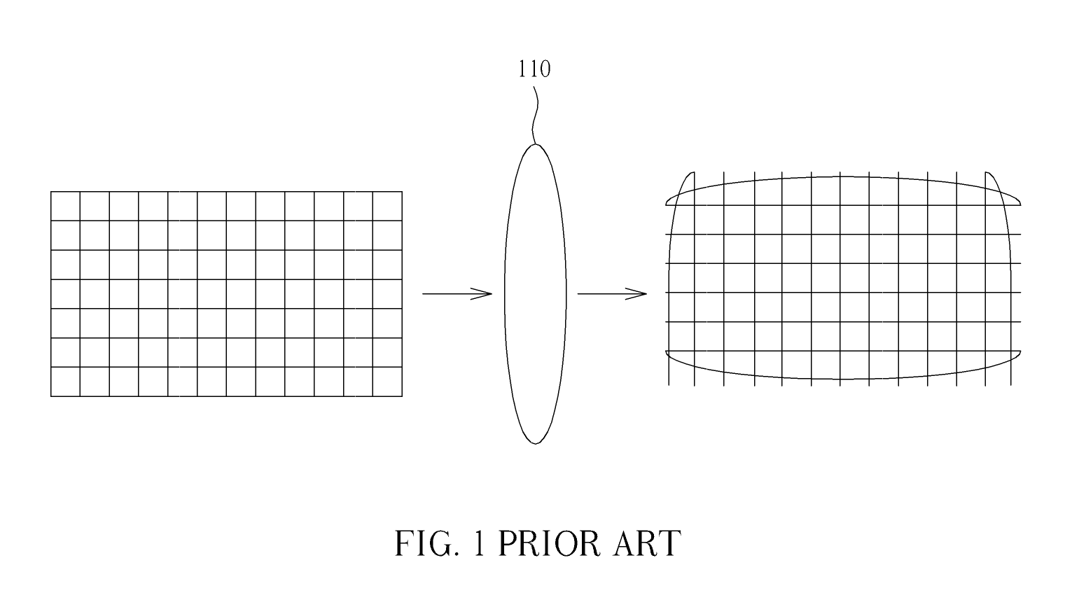

FIG. 2 is a diagram illustrating a calibration system according to one embodiment of the present invention.

FIG. 3 is a diagram illustrating the optical correction unit shown in FIG. 1 according to one embodiment of the present invention.

FIG. 4 is a flowchart of a calibration method of the image projection device shown in FIG. 1 according to one embodiment of the present invention.

FIG. 5 is a flowchart of an image projecting method according to one embodiment of the present invention.

FIG. 6 is a diagram illustrating an operation of the horizontal pre-distortion unit shown in FIG. 3.

FIG. 7 is a diagram illustrating an operation of the vertical pre-distortion unit shown in FIG. 3.

FIG. 8 is a diagram illustrating an operation of the trapezoid pre-distortion unit shown in FIG. 3.

FIG. 9 illustrates the pre-distorted image and the projected image.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

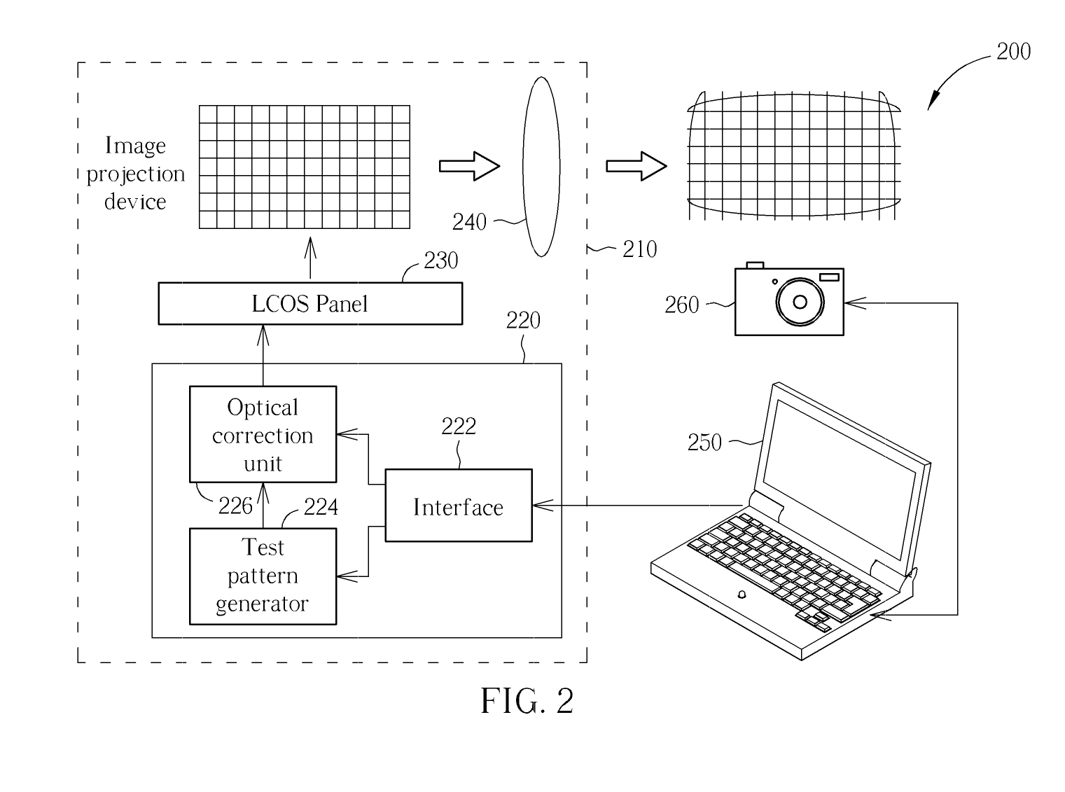

Please refer to FIG. 2, which illustrates a calibration system 200 according to one embodiment of the present invention. As shown in FIG. 2, the calibration system 200 includes an image projection device 210 which is to be calibrated, a host computer 250 and a camera 260, where the image projection device 210 includes a chip 220 including an interface 222, a test pattern generator 224 and an optical correction unit 226, a panel (in this embodiment, a liquid crystal on silicon (LCOS) panel 230 serves as the panel) and a lens 240. In this embodiment, the camera 260 and the image projection device 210 are connected to the host computer 250 via a universal serial bus (USB) interface, but this is not a limitation of the present invention. The lens 240 is positioned in front of the LCOS panel 230, and the images projected from the LCOS panel 230 passes through the lens 240.

In this embodiment, the image projection device 210 is a head-mounted display.

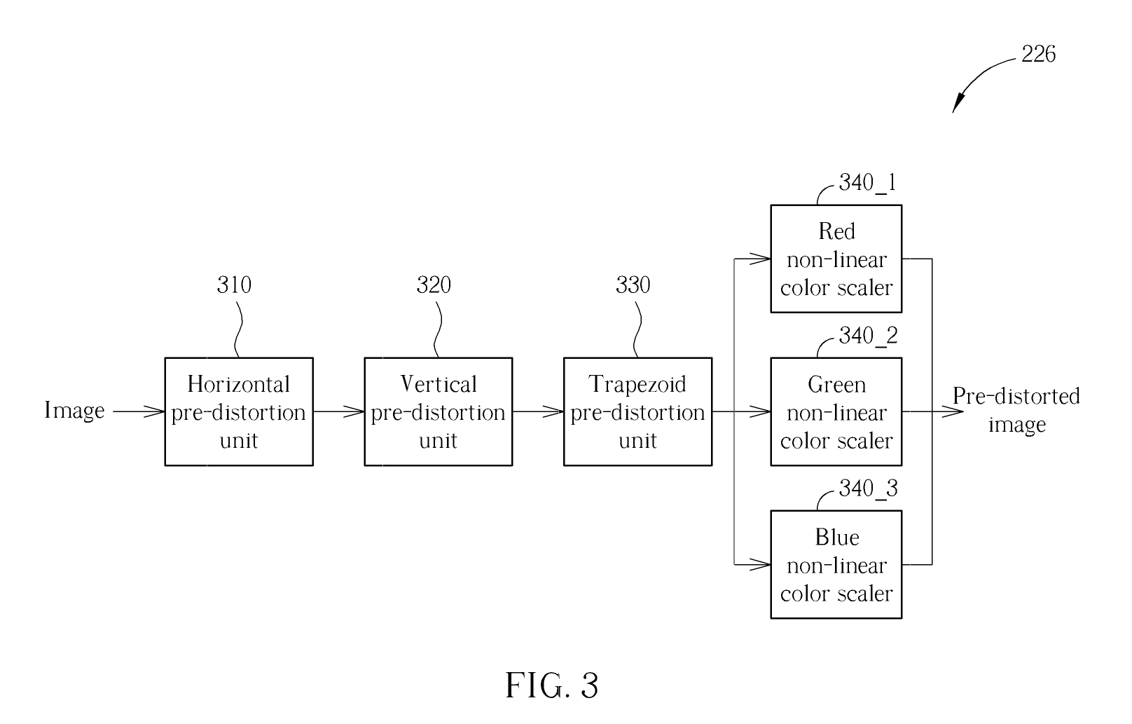

Please refer to FIG. 3, which illustrates the optical correction unit 226 according to one embodiment of the present invention. As shown in FIG. 3, the optical correction unit 226 includes a horizontal pre-distortion unit 310, a vertical pre-distortion unit 320, a trapezoid pre-distortion unit 330 and three non-linear color scalers, i.e. a red non-linear color scaler 340_1, a green non-linear color scaler 340_2 and a blue non-linear color scaler 340_3.

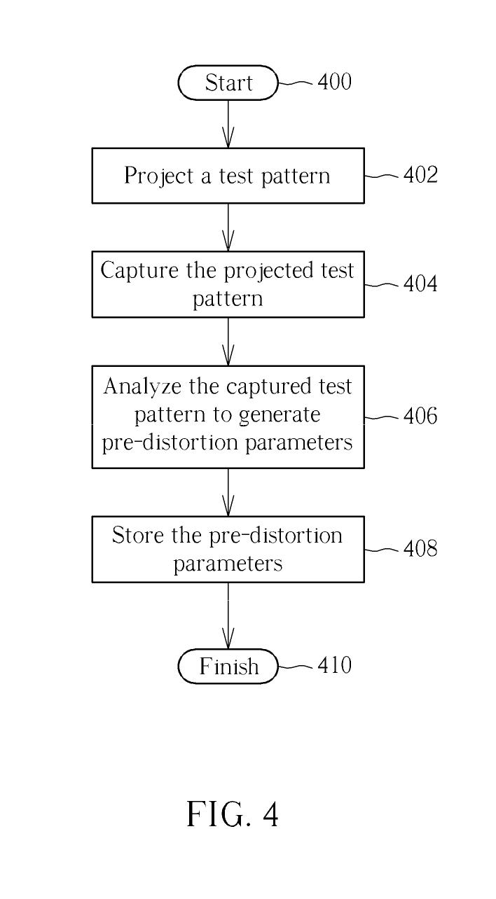

Please refer to FIGS. 2-4 together. FIG. 4 is a flowchart of a calibration method of the image projection device 210 according to one embodiment of the present invention. Referring to FIG. 4, the flow is described as follows.

In Step 400, the flow starts. In Step 402, the image projection device 210 projects a test pattern, where the test pattern can be applied by the host computer 250 or applied by the test pattern generator 224 which stores the built-in test pattern. In this embodiment, the test pattern is a rectangular image, and this rectangular image bypasses the horizontal pre-distortion unit 310, a vertical pre-distortion unit 320, a trapezoid pre-distortion unit 330 and three non-linear color scalers 340, and is projected by the LCOS panel 230 (i.e. the optical correction unit 226 is disabled). Due to the lens effect, the projected image is distorted by the lens.

In Step 404, the camera 260 captures the distorted image and sends the captured image to the host computer 250. In Step 406, the host computer 205 analyzes the captured image with the test pattern to generate pre-distortion parameters, where the pre-distortion parameters correspond to distortion effects caused by the lens 240.

In Step 408, the host computer 250 transmits the pre-distortion parameters to the image projection device 210, and the image projection device 210 stores these pre-distortion parameters in a storage unit (not shown). In Step 410, the calibration is finished.

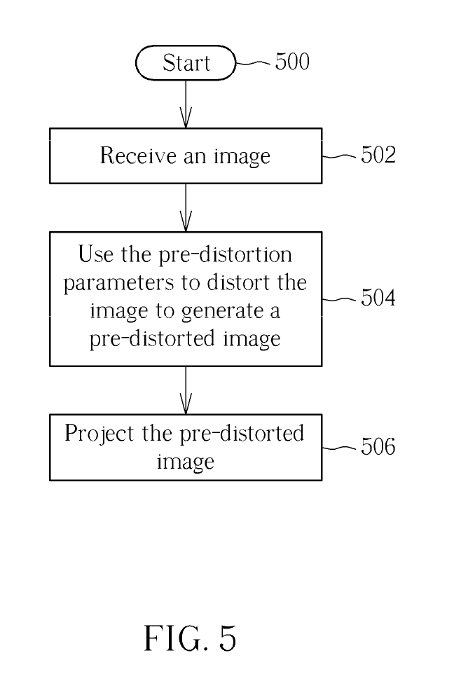

After the pre-distortion parameters are stored and the calibration is finished, the pre-distortion parameters stored in the storage unit are used by the optical correction unit 226 to pre-distort the receive image so as to eliminate the distortion effects caused by the lens 260. Please refer to FIG. 5, which is a flowchart of an image projecting method according to one embodiment of the present invention. Referring to FIG. 5, the flow is described as follows.

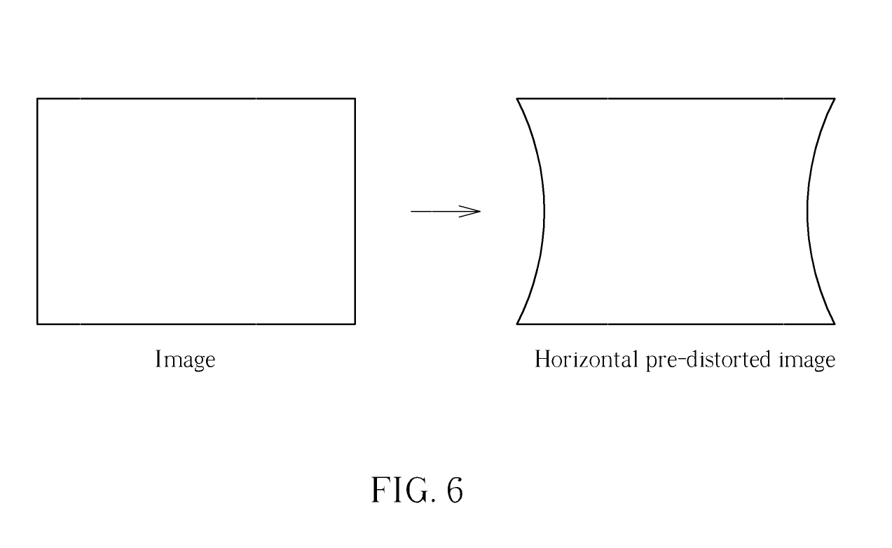

In Step 500, the flow starts. In Step 502, the optical correction unit 226 receives an image. In Step 504, the optical correction unit 226 utilizes the pre-distortion parameters to pre-distort the image to generate a pre-distorted image. For a more detailed illustration of the horizontal pre-distortion, please refer to FIG. 6. As shown in the diagram, the horizontal pre-distortion unit 310 scales at least a portion of the horizontal lines of the image to generate a horizontal pre-distorted image, where the horizontal lines are scaled in a non-linear manner so as to make the left or right side of the horizontal pre-distorted image seem like a curve. For example, the horizontal lines of the image can be divided into a plurality of sections, where each section corresponds to its own scaling ratio, and the horizontal pre-distortion unit 310 scales the horizontal lines for each section with a corresponding scaling ratio.

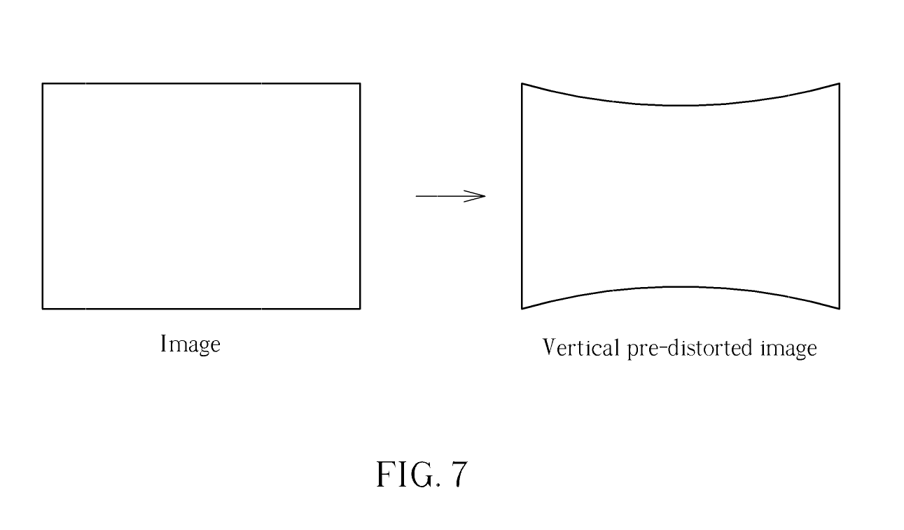

For a more detailed illustration of the vertical pre-distortion, please refer to FIG. 7. As shown in the diagram, the vertical pre-distortion unit 320 scales at least a portion of the vertical lines of the image to generate a vertical pre-distorted image, where the vertical lines are scaled in a non-linear manner so as to make the up or down side of the vertical pre-distorted image seem like a curve. For example, the vertical lines of the image can be divided into a plurality of sections, where each section corresponds to its own scaling ratio, and the vertical pre-distortion unit 320 scales the vertical lines for each section with a corresponding scaling ratio.

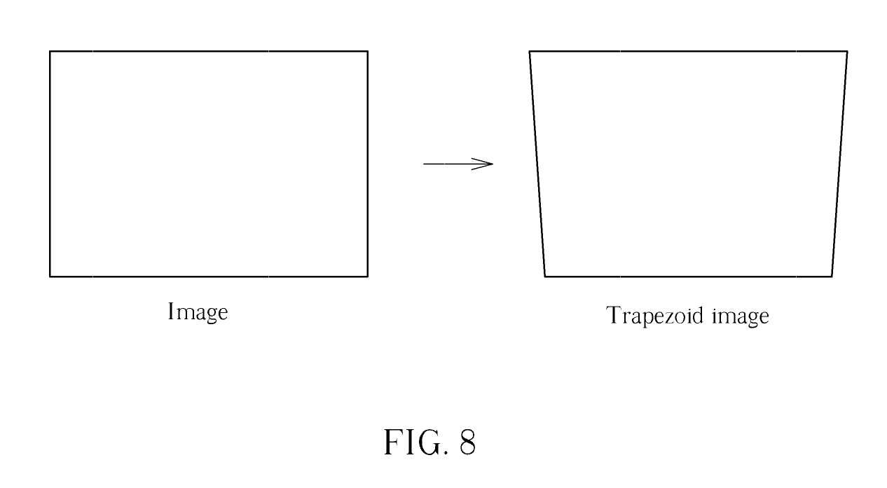

Furthermore, the trapezoid pre-distortion unit 330 re-shapes the image to be a trapezoid as shown in FIG. 8.

In addition, the red non-linear color scaler 340_1, the green non-linear color scaler 340_2 and the blue non-linear color scaler 340_3 adjusts positions of red, green and blue sub-pixels of the image according to at least a portion of the pre-distortion parameters in a non-linear matter. In detail, because the degree of the color separation (lateral chromatic aberration) is varied with the positions of the image (i.e. the middle vertical line has a slight color separation, and the vertical lines near the left/right side have serious color separation), the red non-linear color scaler 340_1, the green non-linear color scaler 340_2 and the blue non-linear color scaler 340_3 shift the red, green and blue sub-pixels, respectively, in the non-linear matter so as to eliminate the color separation of the image.

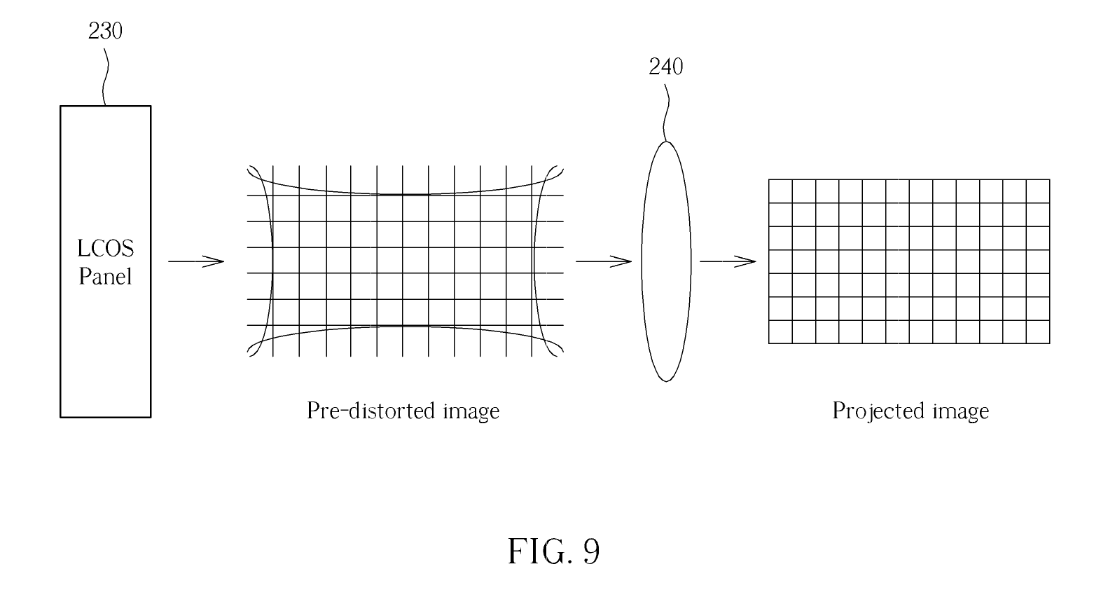

In Step 506, the LCOS panel 230 receives the pre-distorted image and projects this pre-distorted image. Referring to FIG. 9 which illustrates the pre-distorted image and the projected image, the projected image is the pre-distorted image passing through the lens 240 and the projected image is a rectangular image whose shape is the same as the original image. That is, the distortion effect and color separation issue caused by the lens 240 are eliminated.

It should be noted that the executing sequence of the horizontal pre-distortion unit 310, the vertical pre-distortion unit 320, the trapezoid pre-distortion unit 330 and three non-linear color scalers 340 shown in FIG. 2 is for illustrative purposes only, and is not meant to be a limitation of the present invention. In other embodiments, the executing sequence of the horizontal pre-distortion unit 310, the vertical pre-distortion unit 320, the trapezoid pre-distortion unit 330 and three non-linear color scalers 340 can be interchanged without influencing the operations of the optical correction unit 226.

In addition, the trapezoid pre-distortion unit 330 is an optional device. In another embodiment of the present invention, the trapezoid pre-distortion unit 330 can be removed from the optical correction unit 226, or the functions of the trapezoid pre-distortion unit 330 can be integrated into the horizontal pre-distortion unit 310 and the vertical pre-distortion unit 320.

Briefly summarized, in the image projection device and associated image projection method and calibration method, the image projection device can pre-distort an image to generate a pre-distorted image. The image projection device then projects this pre-distorted image to eliminate the distortion effect and color separation issue caused by the lens. Therefore, the quality of the projected image will be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image projection device, comprising:
an optical correction unit, for receiving an image and pre-distorting the image to generate a pre-distorted image according to pre-distortion parameters;
a panel, coupled to the optical correction unit, for receiving and projecting the pre-distorted image; and
a lens, positioned in front of the panel, wherein the pre-distorted image projected from the panel passes through the lens;
wherein the pre-distortion parameters correspond to distortion effects caused by the lens.

2. The image projection device of claim 1, wherein the optical correction unit comprises:
a horizontal pre-distortion unit and a vertical pre-distortion unit, for scaling at least a portion of horizontal lines and vertical lines of the image, respectively, according to at least a portion of the pre-distortion parameters.

3. The image projection device of claim 1, wherein the optical correction unit comprises:
a horizontal pre-distortion unit, a vertical pre-distortion unit and a trapezoid pre-distortion unit, for scaling at least a portion of horizontal lines of the image, scaling at least a portion of vertical lines of the image and re-shaping the image to be a trapezoid, respectively, according to at least a portion of the pre-distortion parameters.

4. The image projection device of claim 1, wherein the optical correction unit comprises:
a plurality of non-linear color scalers, for adjusting positions of red, green and blue sub-pixels of the image according to at least a portion of the pre-distortion parameters.

5. The image projection device of claim 1, applied to a head-mounted display.

6. An image projecting method, comprising:
receiving an image and pre-distorting the image to generate a pre-distorted image according to pre-distortion parameters;
providing a panel to project the pre-distorted image; and
providing a lens, positioned in front of the panel, wherein the pre-distorted image projected from the panel passes through the lens;
wherein the pre-distortion parameters correspond to distortion effects caused by the lens.

7. The image projecting method of claim 6, wherein the step of generating the pre-distorted image according to pre-distortion parameters comprises:
scaling at least a portion of horizontal lines and vertical lines of the image, respectively, according to at least a portion of the pre-distortion parameters.

8. The image projecting method of claim 6, wherein the step of generating the pre-distorted image according to pre-distortion parameters comprises:
scaling at least a portion of horizontal lines of the image, scaling at least a portion of vertical lines of the image and re-shaping the image to be a trapezoid, respectively, according to at least a portion of the pre-distortion parameters.

9. The image projecting method of claim 6, wherein the step of generating the pre-distorted image according to pre-distortion parameters comprises:
adjusting positions of red, green and blue sub-pixels of the image according to at least a portion of the pre-distortion parameters.

10. The image projecting method of claim 6, applied to a head-mounted display.

11. A calibration method, comprising:
providing an image projection device;
utilizing the image projection device to project a test pattern;
capturing the test pattern projected from the image projection device;
analyzing the captured test pattern to generate pre-distortion parameters, where the pre-distortion parameters correspond to distortion effects caused by a lens of the image projection device; and
utilizing the image projection device to store the pre-distortion parameters.

12. The calibration method of claim 11, applied to a head-mounted display.
